(19) United States
(12) Patent Application Publication
(10) Pub. No.: US 2016/0338019 A1
(43) Pub. Date: Nov. 17, 2016

(54) UNLICENSED BAND TRANSMISSION

(71) Applicant: NOKIA TECHNOLOGIES OY, Espoo (FI)

(72) Inventors: Rapeepat RATASUK, Hoffman Estates, IL (US); Mikko UUSITALO, HELSINKI (FI); Nitin MANGALVEDHE, Hoffman Estates, IL (US); Zexian LI, Espoo (FI)

(21) Appl. No.: 15/111,270

(22) PCT Filed: Jan. 31, 2014
(86) PCT No.: PCT/US2014/014125

§ 371 Date: Jul. 13, 2016

(51) Int. Cl. H04W 72/04; H04W 24/10; H04W 16/14

(52) U.S. Cl. CPC H04W 72/042; H04W 16/14; H04W 72/0453; H04W 24/10

(57) ABSTRACT

Methods and apparatus, including computer program products, are provided for unlicensed transmission. In one aspect there is provided a method. The method may include receiving a resource allocation in terms of at least one of a time and a frequency; determining whether a measurement on the allocated frequency is required; performing the measurement on the allocated frequency, when the measurement on the allocated frequency is required; and transmitting on the allocated frequency, when the allocated frequency is clear based on the performed measurement. Related apparatus, systems, methods, and articles are also described.

### FIELD

The subject matter disclosed herein relates to wireless communications.

### BACKGROUND

User equipment may be configured to operate in different modes, such as using cell-to-device links (C2D) and/or device-to-device (D2D) links.

Carrier aggregation refers to using one or more portions of the radio frequency spectrum (also referred to as spectrum chunks) to carry data between the user equipment and the network—increasing thus data throughput, when activated by the network. These spectrum chunks may be contiguous or non-contiguous and may be symmetric or asymmetric (for example, a different quantity of spectrum chunks allocated to the uplink and downlink). Typically, one of the spectrum chunks is designated a primary cell, serving as an anchor carrier, while one or more other spectrum chunks are referred to as secondary cells. Carrier aggregation may be under the control of a network to provide the cell-to-device (C2D) links used for the primary carrier and secondary carrier(s) serving the primary and secondary cells.

Device-to-device (D2D) communications refers to direct connections between user equipment, such as cell phones, smart phones, and other devices. The D2D communication may for example provide a direct WiFi connection or a Bluetooth connection between the user equipment.

### SUMMARY

Methods and apparatus, including computer program products, are provided for unlicensed transmission.

In some example embodiments, there is provided a method. The method may include receiving a resource allocation in terms of at least one of a time and a frequency; determining whether a measurement on the allocated frequency is required; performing the measurement on the allocated frequency, when the measurement on the allocated frequency is required; and transmitting on the allocated frequency, when the allocated frequency is clear based on the performed measurement.

In some example embodiments, one of more variations may be made as well as described in the detailed description below and/or as described in the following features. The resource allocation may include a scheduling assignment allocating at least the frequency in an unlicensed frequency band. The scheduling assignment may include a request to make the measurement on the allocated frequency before at least one of the receiving, the determining, the performing, and the transmitting. The request to make the measurement may be based on information on whether other transmitters exist on the allocated frequency. The scheduling assignment may include an indication to send a measurement report to a base station and/or via another channel during the transmitting. The scheduling assignment may include the resource allocation for a direct link to a base station and/or a link to another device. The transmitting on the allocated frequency may occur when the measurement is below a threshold and/or the measurement is not required. When the measurement is above the threshold, the measurement may be fed back to a base station, when the measurement is above a threshold. The measurement may include a reference signal, received power measurement, an estimated quality of service, and/or an interference level.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example of a system, in accordance with some example embodiments;

FIG. 2 depicts another example of a system, in accordance with some example embodiments;

FIGS. 3A-3B depict examples of processes for using unlicensed frequency bands, in accordance with some example embodiments;

FIG. 4 depicts an example of a user equipment, in accordance with some example embodiments; and

FIG. 5 depicts an example of an access point, in accordance with some example embodiments.

Like labels are used to refer to same or similar items in the drawings.

### DETAILED DESCRIPTION

In unlicensed frequency bands, some jurisdictions impose requirements for use, such as power restrictions and/or a listen before transmit protocol. For example, if a WiFi transceiver in the 5 GHz band operates in Europe, it may be required to comply with a fairness and/or a coexistence mechanism, such as listen before talk or a request to send/clear to send reservation. That same WiFi transmitter in the U.S. and South Korea may, however, only need to limit transmit power.

In device-to-device (D2D) communications, a network, such as a base station, may provide network assistance. This network assistance may provide management of radio frequency interference, which may enhance reliable D2D communication. When this is the case, the base station may manage frequency resources being used for D2D transmissions within the cell being served by the base station. This frequency management may enable time and/or frequency reuse of available resources.

In some example embodiments, a network assisted or controlled allocation of unlicensed carrier frequencies may be provided, and the allocated, unlicensed carrier frequencies may be used under a listen before talk protocol. Moreover, the allocated unlicensed carrier frequencies may, under the control of the network, provide one or more D2D links and/or one or more C2D links, such as carrier aggregation links for a secondary carrier.

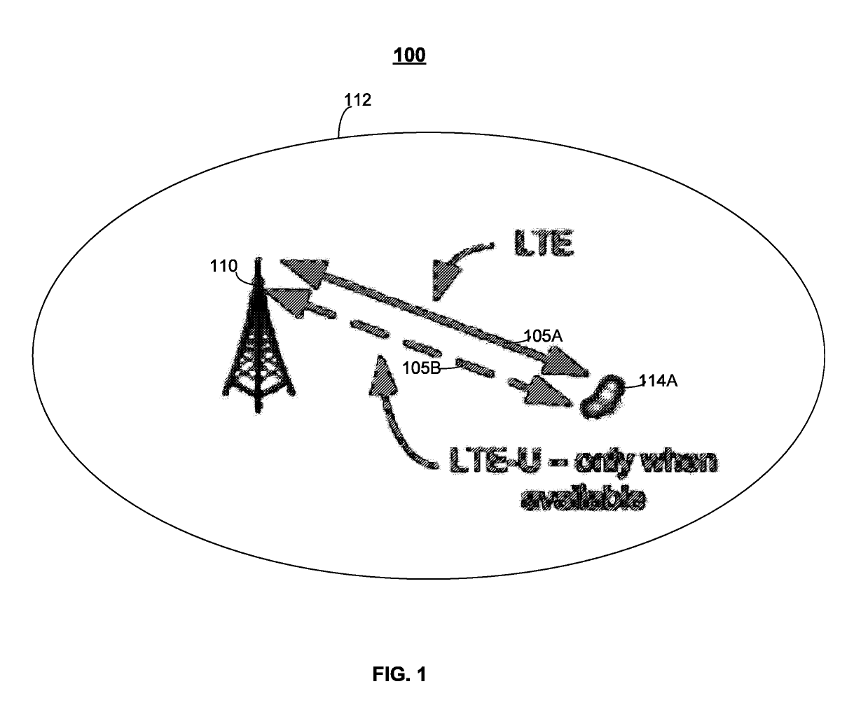

FIG. 1 depicts a system 100 including a base station 110 serving a cell 112 including user equipment 114A, in accordance with some example embodiments. The system 100 may further include one or more links 105A, such as an uplink and/or a downlink, which are assigned a time and/or frequency resource by the network/base station 110 from a licensed portion of the spectrum (for example, a band allowed for use with Long Term Evolution (LTE) and the like). However, one or more links 105B, such as an uplink and/or a downlink, may be assigned a time and/or frequency resource by the network/base station 110 from an unlicensed portion of the spectrum.

The network/base station 110 may assign to one or more links 105B (labeled LTE-U) one or more carrier frequencies from the unlicensed frequency band(s). This resource allocation may be provided as part of a scheduling assignment sent by the network to user equipment 114A. For example, network/base station 110 may assign to user equipment 114A one or more carrier frequencies from the unlicensed band(s) for links 105B, and this assignment may include a time resource (or schedule) as well.

In some example embodiments, network/base station 110 may configure one or more links 105B as one or more secondary carriers for carrier aggregation. In addition, the traffic carried by secondary carriers via links 105B (which is in an unlicensed band) may be restricted to only data transmission, such as user plane data, and the traffic carried by a primary carrier over links 105A (which is in a licensed band) may be restricted to control data (for example, C-plane and L1-control).

In some example embodiments, the use of the unlicensed spectrum includes a listen-before-talk aspect or a request to send/clear to send protocol. By using listen-before-talk, the assignment of unlicensed frequency resources may allow co-existence with other unlicensed frequency usage, such as WiFi and the like, and may accommodate a wider range of jurisdictions. Referring to FIG. 1, network/base station 110 may provide a resource allocation to user equipment 114A, and this resource allocation may indicate that user equipment 114A should listen (for example, measure) the interference level before transmitting (for example, “talking”) on the assigned unlicensed frequency carrier. Although the previous example described user equipment 114A measuring for interference on the allocated unlicensed frequency, other devices including the network may also measure for interference on the allocated unlicensed frequency (in which case the network/base station may not request the user equipment 114A to measure the interference on the allocated unlicensed frequency).

In some example embodiments, if base station 110 selects resources in the unlicensed band, the base station may first sense (for example, using carrier sensing or clear channel assessment based on interference measurements). If clear, the base station may reserve a frequency carrier (or channel) for a certain amount of time (for example, using RTS/CTS) or hold the channel (for example, by transmitting beacons or other signals). The base station may then assign the reserved unlicensed frequency resources to a user equipment.

In some example embodiments, the one or more links 105B on the unlicensed frequency may operate in a half-duplex mode. For example, an uplink and downlink carried by links 105 serving for example as carrier aggregation secondary carrier) may be operated in a half-duplex mode, so that transmission occurs on one of the uplink or the downlink at any given time.

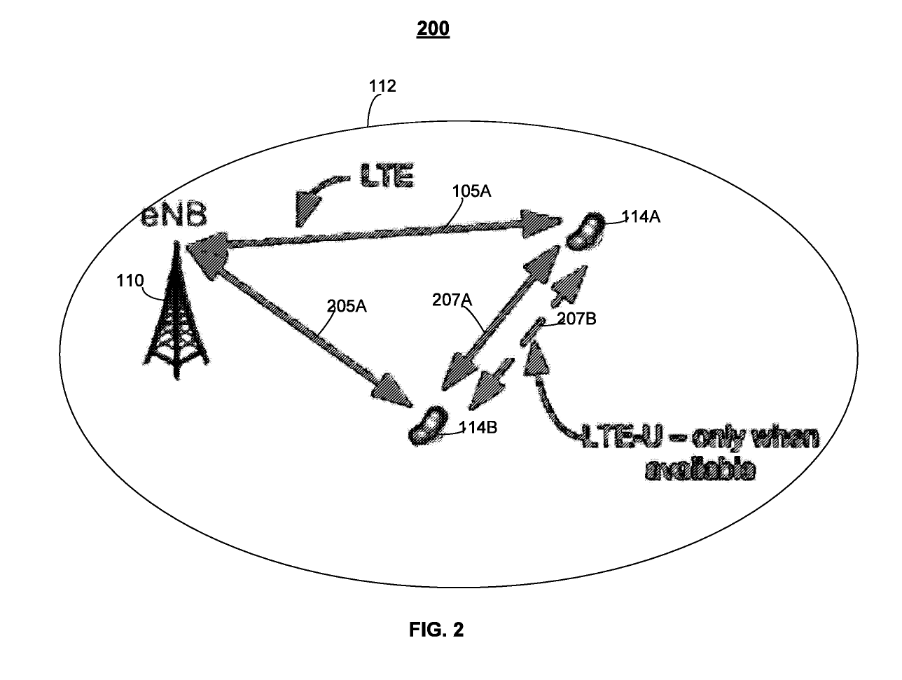

FIG. 2 depicts a system 200 including base station 110 and serving cell 112 including user equipment 114A and 114B, in accordance with some example embodiments.

System 200 may include further include links 105A and 205A, which may be in the licensed band of carrier frequencies (for example, licensed for use with LTE). System 200 may, in some example embodiments, further include D2D links 207A-B. In the example of FIG. 2, D2D link 207A is allocated a frequency from a licensed band, but the network/base station 110 may, in some example embodiments, allocate the frequency for links 207B from an unlicensed band.

In some example embodiments, the use of the unlicensed spectrum includes a listen-before-talk aspect or a request to send/clear to send protocol. Referring to FIG. 2, network/base station 110 may provide a resource allocation to user equipment 114A, and this resource allocation may indicate that user equipment 114A should listen (for example, measure) for the interference level before transmitting (for example, “talking”) on the assigned unlicensed frequency carrier(s) allocated for links 207B. Although the previous example described user equipment 114A measuring for interference on the allocated unlicensed frequency, other devices including the network may also measure for interference on the allocated unlicensed frequency (in which case the network/base station may not request the user equipment 114A to measure the interference on the allocated unlicensed frequency). In some example embodiments, if the base station selects resources in the unlicensed band, the base station may sense, reserve, and assign the unlicensed frequency as noted above.

In FIGS. 1 and 2, the solid links 105A, 205A, and 207A represent links using licensed frequency bands, while the dashed links 105B and 207B represent unlicensed frequency bands. Although FIG. 2 depicts a single link 207B using a frequency from the unlicensed frequency band, additional links including link 207A, 105A and 205A may be allocated a resource from the unlicensed frequency band as well.

In some example embodiments, base station 110 may include (or have access to) information regarding available resources in time and frequency in the licensed and unlicensed bands. Moreover, the resources may include geographic information providing a map of available resources. Although licensed resources may be known a priori, an unlicensed resource may not be available at any given time as an unlicensed resource may be in use by another device. As such, the base station may perform periodic sensing and/or receive feedback measurements/reports from user equipment to have information regarding available resources.

In some example embodiments, the network/base station may allocate unlicensed frequency resources based on a prioritization scheme. For example, when a base station 110 receives a request for a resource from user equipment 114A or 114B (for a C2D link and/or a D2D link), base station 110 may assign the requested unlicensed frequency based on a prioritization scheme.

In some example embodiments, the network/base station may use licensed carrier frequencies, such as links 105A and 205A to transmit the scheduling assignment of resources including the allocated frequency resources.

In some example embodiments, the base station may request a user equipment to send back a measurement report to the base station. For example, the request may specifically request a reference signal, received power (RSRP) measurement report of the unlicensed frequency band including any assigned or potentially assigned carrier frequencies in the unlicensed band. To illustrate further, the request may request a measurement report of the background interference level on any carrier frequencies in the unlicensed frequency band during a period of no transmission from the base station.

In some example embodiments, the user equipment may listen at a assigned, unlicensed frequency by for example performing a reference signal, received power (RSRP) measurement (or other measurement type) to determine whether the assigned, unlicensed frequency is currently being used by another device. For example, a measurement on the assigned unlicensed frequency may indicate an interference level, and thus whether the assigned resource is clear to send. This measurement may detect an unlicensed transmission (for example, WiFi transmissions and the like) using the assigned, unlicensed frequency. In some example embodiments, if the measured interference level is below a certain threshold, the assigned unlicensed frequency is clear, so the user equipment may transmit on the assigned unlicensed frequency. However, if the measured interference level is at or below the certain threshold, the user equipment may abort transmission and report to the base station that the assigned unlicensed frequency is not currently clear (or free) to use.

In example embodiments in which an uplink transmission uses an unlicensed frequency (for example, C2D uplink transmission, secondary carrier, and the like), the base station may request the user equipment to include a RSRP measurement report (regarding the unlicensed frequency) in the uplink data carried by the unlicensed frequency (although the report may be sent via a licensed carrier band as well). In some example D2D embodiments, the base station may request the user equipment to include the RSRP measurement report (regarding the unlicensed frequency) in a control channel, such as via a control (C)-plane transmission on a licensed band.

Moreover, the base station may, in some example embodiments, use feedback from one or more user equipment to for example discover hidden nodes, assess unlicensed band usage, identify which user equipment can use unlicensed bands, adapt the RSRP threshold used in RSRP measurements of the interference on an unlicensed frequency, and the like.

In some example embodiments, the base station may use measurements provided by user equipment to determine the need for the user equipment and/or other user equipment to perform additional listening/measurement and feedback the additional listening/measurement. This additional listening may provide information regarding whether an assigned, unlicensed frequency is clear and detect for example hidden transmit nodes.

In some example embodiments, the user equipment may implement a dynamic measurement mode in which a measurement request is included in the scheduling assignment sent by the base station to the user equipment. The user equipment may also implement a semi-statically configured measurement mode configuration in which the measurement request is signaled as part of the radio resource control (RRC) signaling. The base station may use feedback from one or more user equipment to improve unlicensed operations.

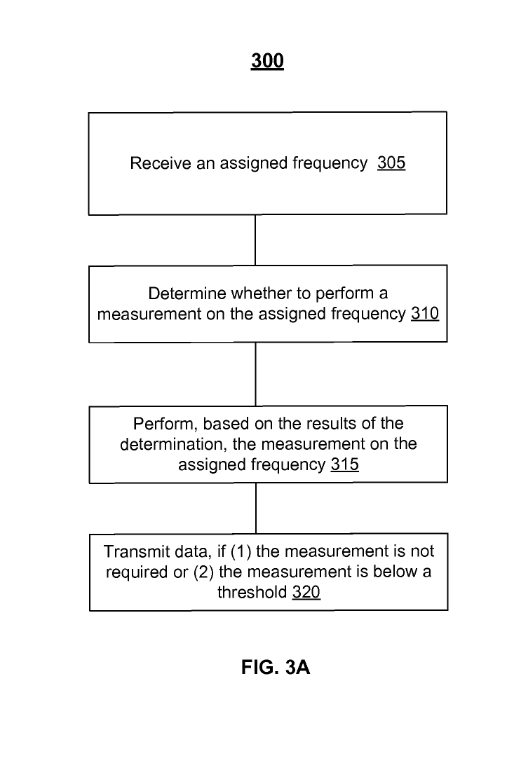

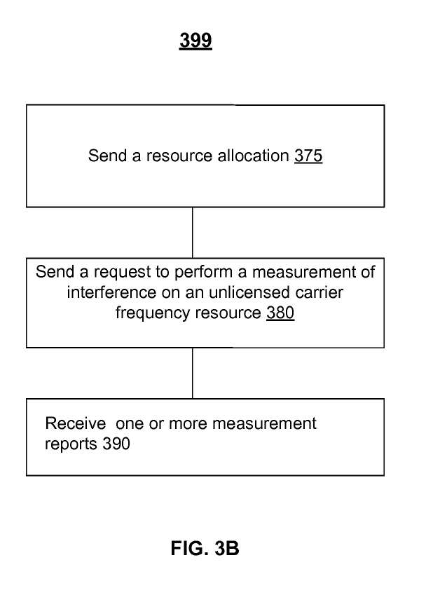

FIG. 3A depicts an example of a process 300 for a user equipment utilizing an unlicensed frequency band, in accordance with some example embodiments. The description of FIG. 3A also refers to FIGS. 1 and 2.

At 305, user equipment 114A may receive a resource allocation in terms of time and/or frequency for a link, in accordance with some example embodiments. For example, base station 110 may send to user equipment 114A a resource allocation in terms of time and/or frequency, and this resource allocation may be sent as a scheduling assignment. In some example embodiments, the resource allocation may be for a frequency in an unlicensed frequency band and/or a licensed frequency band. Moreover, the unlicensed frequency resource may be for a D2D link, such as 207B, and/or a C2D link, such as links 105B.

At 310, user equipment 114A may determine whether to perform a measurement on the assigned frequency, in accordance with some example embodiments. When the allocated resource is for an unlicensed frequency, the user equipment may be required, in some example embodiments, to perform one or more measurements to see if the allocated unlicensed frequency is clear to use. In some example embodiments, the network/base station 110 may signal (for example, via the scheduling assignment, RRC signaling, and the like) the user equipment 114A to perform an interference measurement on the allocated unlicensed frequency to determine whether the allocated unlicensed frequency is clear to use (for example, not currently being used by another device). However, the network/base station 110 may obtain interference measurements for the unlicensed frequency bands from devices other than user equipment 114A (for example, from other devices or by making direct measurements by the network/base station), so the network/base station 110 may not request the user equipment to perform interference measurements of the an unlicensed frequency. Moreover, the user equipment may not need to perform interference measurements on an allocated resource if the frequency is licensed, such as a frequency in a licensed LTE band.

At 315, user equipment 114A may perform, based on the results of the determination at 310, a measurement on the assigned unlicensed frequency, in accordance with some example embodiments. For example, the user equipment may perform a measurement of the interference on the allocated unlicensed frequency, and if the interference measurement is below certain threshold, the allocated unlicensed frequency is likely not in use. However, if the interference measurement is at or above the threshold, the allocated unlicensed frequency is likely in use.

At 320, if a measurement is not required per 310 or a performed measurement is below a threshold (indicative of an unlicensed frequency carrier not currently in use), user equipment 114A may transmit data on the assigned frequency. For example, if a measurement is not required per 310, the allocated resource is either (1) licensed or (2) the network has information indicating that the allocated unlicensed frequency resource is clear to use, in either case the user equipment 114A may send data on the allocated resource. Moreover, if an interference measurement is required and the interference measurement is below a threshold (which also indicates the allocated unlicensed resource is clear to use), the user equipment 114A may send (for example, transmit) data on the allocated resource. This transmission may include, in some example embodiments, user equipment 114A transmitting data on a secondary carrier 105B being carried by the allocated unlicensed frequency resource, and/or user equipment 114A transmitting data on a D2D link 207B carried by the allocated unlicensed frequency resource.

FIG. 3B depicts an example of a process 399 for a network/base station assigning resources including time and/or frequency resources in an unlicensed frequency band, in accordance with some example embodiments.

At 375, base station 110 may send to user equipment 114A a resource allocation in terms of time and/or frequency for a link, in accordance with some example embodiments. For example, base station 110 may send to user equipment 114A a resource allocation in terms of time and/or frequency, and this resource allocation may be sent as a scheduling assignment. In some example embodiments, the resource allocation may be for a frequency in an unlicensed frequency band (for example, D2D link, such as 207B, and/or a C2D link, such as links 105B) and/or a licensed frequency band.

At 380, base station 110 may send to user equipment 114A a request to perform a measurement of the interference on the allocated, unlicensed frequency, in accordance with some example embodiments. This request may, in some example embodiments, may be provided in the resource allocation (or scheduling assignment) sent at 375 and/or at other times as well, such as for example via RRC signaling to the user equipment 114. Moreover, base station 110 may perform measurements of the interference on the allocated, unlicensed frequency, and/or request devices other than user equipment 114A to make measurements of the interference on the allocated, unlicensed frequency.

At 390, base station 110 may receive one or more measurement reports from one or more devices, in accordance with some example embodiments. For example, base station 110 may receive a measurement report including the interference measured at 380 by user equipment 114A and/or measured by other devices as well.

In some example embodiments, user equipment may be configured to perform RSRP measurement on the unlicensed band based on an RSRP measurement on the licensed band. In some example embodiments, the base station may determine whether one or more user equipment is in proximity to hidden WiFi node(s) based on unlicensed frequency RSRP measurement report or the absence of transmission by a user equipment when scheduled. In some example embodiments, the base station may determine whether to signal the user equipment to make measurements based on whether the user equipment is in the proximity of one or more hidden WiFi nodes.

Referring again to FIGS. 1 and 2, user equipment 114A-B may be implemented as a mobile device and/or a stationary device. The user equipment 114A-B are often referred to as, for example, mobile stations, mobile units, subscriber stations, wireless terminals, tablets, smart phones, wireless devices, devices, or the like. A user equipment may be implemented as, for example, a wireless handheld device, a wireless plug-in accessory, or the like. In some example embodiments, the user equipment may include one or more processors, one or more computer-readable storage medium (for example, memory, storage, and the like), one or more radio access components (for example, a modem, a transceiver, and the like), and/or a user interface. The computer readable medium may include code which when executed by a processor provides one or more applications.

In some example embodiments, the user equipment 114A-B may be implemented as multi-mode user devices configured to operate using a plurality of radio access technologies, although a single-mode device may be used as well. For example, user equipment 114A-B may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies. Moreover, the user equipment 114A-B may be configured to have established connections to access points using a plurality of the radio access technologies.

The base station 110 may, in some example embodiments, be implemented as an evolved Node B (eNB) type base station, although other types of radio access points may be implemented as well. When the evolved Node B (eNB) type base station is used, the base stations, such as base station may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer-Measurements, and any subsequent additions or revisions to these and other 3GPP series of standards (collectively referred to as LTE standards). The base station may also be configured to serve cells using a WLAN technology, such as WiFi (for example, the IEEE 802.11 series of standards), as well as any other radio access technology capable of serving a cell.

Although FIGS. 1 and 2 depicts a specific quantity and configuration of base stations, cells, and user equipment, other quantities and configurations may be implemented as well.

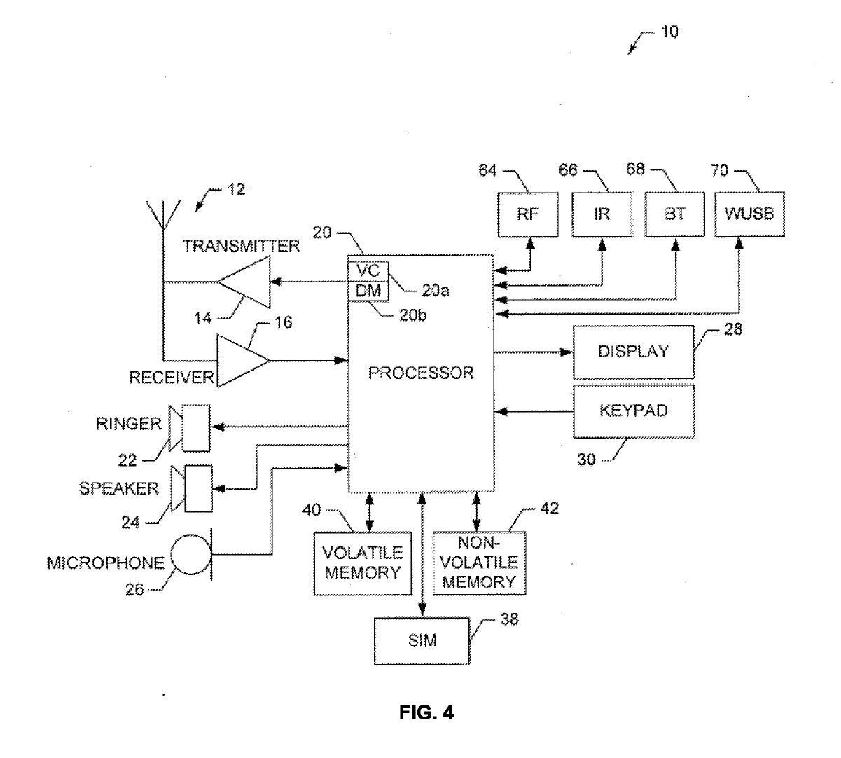

FIG. 4 illustrates a block diagram of an apparatus 10, in accordance with some example embodiments. For example, apparatus 10 may comprise a radio, such as a user equipment, a smart phone, mobile station, a mobile unit, a subscriber station, a wireless terminal, a tablet, a wireless plug-in accessory, a wireless access point, a base station, and/or or any other device with device having a transceiver.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth (BT) transceiver 68 operating using Bluetooth wireless technology, a wireless universal serial bus (USB) transceiver 70, a Bluetooth Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), a eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing process 300, 399, and other operations associated with a user equipment. The memories may comprise an identifier, such as an international mobile equipment identification (IMEI) code, capable of uniquely identifying apparatus 10. The functions may include one or more of the operations disclosed herein with respect to the user equipment. The memories may comprise an identifier, such as an international mobile equipment identification (IMEI) code, capable of uniquely identifying apparatus 10. In the example embodiment, the processor 20 may be configured using computer code stored at memory 40 and/or 42 to operations disclosed herein including receiving a resource allocation in terms of at least one of a time and a frequency; determining whether a measurement on the allocated frequency is required; performing the measurement on the allocated frequency, when the measurement on the allocated frequency is required; and transmitting on the allocated frequency, when the allocated frequency is clear based on the performed measurement.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer. For example, the computer-readable medium may include computer program code which when executed by processor circuitry may provide operations disclosed herein with respect to processes 300, 399, and the like.

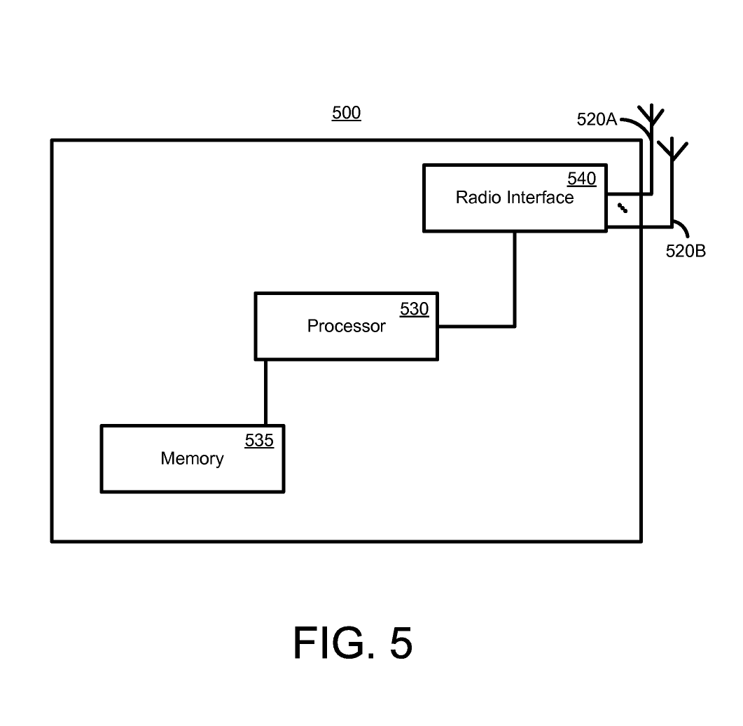

FIG. 5 depicts an example implementation of a wireless access point 500, which may be implemented at one or more of base stations 110, in accordance with some example embodiments. The wireless access point may include one or more antennas 520 configured to transmit via downlinks and configured to receive uplinks via the antenna(s) 520. The wireless access access point may further include a plurality of radio interfaces 540 coupled to the antenna(s) 520. The radio interfaces 540 may correspond to a plurality of radio access technologies including one or more of LTE, WLAN, Bluetooth, Bluetooth low energy, NFC, radio frequency identifier (RFID), ultrawideband (UWB), ZigBee, ANT, and the like. The radio interface 540 may include components, such as filters, converters (for example, digital-to-analog converters and the like), mappers, a Fast Fourier Transform (FFT) module, and the like, to generate symbols for a transmission via one or more downlinks and to receive symbols (for example, via an uplink). The wireless access point may further include one or more processors, such as processor 530, for controlling the wireless access point 500 and for accessing and executing program code stored in memory 535. In some example embodiments, the memory 535 includes code, which when executed by at least one processor, causes one or more of the operations described herein with respect to the base stations/wireless access points. For example, the wireless access point 500 may be configured to send resource allocations, send requests to perform measurements, receive measurement reports, and the like.

Without in any way limiting the scope, interpretation, or application of the claims appearing below, a technical effect of one or more of the example embodiments disclosed herein is centralized control unlicensed frequency resources.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.” The use of the phase “such as” means “such as for example” unless otherwise indicated.

1-20. (canceled)

21. A method, comprising:
receiving a resource allocation in terms of at least one of a time and a frequency;
determining whether a measurement on the allocated frequency is required;
performing the measurement on the allocated frequency, when the measurement on the allocated frequency is required; and
transmitting on the allocated frequency, when the allocated frequency is clear based on the performed measurement.

22. The method of claim 21, wherein the resource allocation comprises a scheduling assignment allocating at least the frequency in an unlicensed frequency band.

23. The method of claim 22, wherein the scheduling assignment includes a request to make the measurement on the allocated frequency before at least one of the receiving, the determining, the performing, and the transmitting.

24. The method of claim 23, wherein the request to make the measurement is based on information on whether other transmitters exist on the allocated frequency.

25. The method of claim 22, wherein the scheduling assignment includes an indication to send a measurement report to a base station and/or via another channel during the transmitting.

26. The method of claim 22, wherein the scheduling assignment includes the resource allocation for a direct link to a base station and/or a link to another device.

27. The method of claim 21, wherein the transmitting on the allocated frequency occurs when the measurement is below a threshold and/or the measurement is not required.

28. The method of claim 21 further comprising:
feeding back to a base station the measurement, when the measurement is above a threshold.

29. The method of claim 21, wherein the measurement comprises a reference signal, received power measurement, an estimated quality of service, and/or an interference level.

30. An apparatus comprising:
at least one processor; and
at least one memory including computer program code, the at least one processor, the at least one memory, and the computer program code configured to cause the apparatus to at least:
receive a resource allocation in terms of at least one of a time and a frequency;
determine whether a measurement on the allocated frequency is required;
perform the measurement on the allocated frequency, when the measurement on the allocated frequency is required; and
transmit on the allocated frequency, when the allocated frequency is clear based on the performed measurement.

31. The apparatus of claim 30, wherein the resource allocation comprises a scheduling assignment allocating at least the frequency in an unlicensed frequency band.

32. The apparatus of claim 31, wherein the scheduling assignment includes a request to make the measurement on the allocated frequency before at least one of the receiving, the determining, the performing, and the transmitting.

33. The apparatus of claim 32, wherein the request to make the measurement is based on information on whether other transmitters exist on the allocated frequency.

34. The apparatus of claim 31, wherein the scheduling assignment includes an indication to send a measurement report to a base station and/or via another channel during the transmitting.

35. The apparatus of claim 31, wherein the scheduling assignment includes the resource allocation for a direct link to a base station and/or a link to another device.

36. The apparatus of claim 30, wherein the transmitting on the allocated frequency occurs when the measurement is below a threshold and/or the measurement is not required.

37. The apparatus of claim 30, wherein the at least one memory including computer program code is further configured to, with the at least one processor, cause the apparatus to at least:
feedback to a base station the measurement, when the measurement is above a threshold.

38. The apparatus of claim 30, wherein the measurement comprises a reference signal, received power measurement, an estimated quality of service, and/or an interference level.

39. A non-transitory computer-readable medium encoded with instructions that, when executed by at least one processor, causes operations comprising:
receiving a resource allocation in terms of at least one of a time and a frequency;
determining whether a measurement on the allocated frequency is required;
performing the measurement on the allocated frequency, when the measurement on the allocated frequency is required; and
transmitting on the allocated frequency, when the allocated frequency is clear based on the performed measurement.

40. The computer-readable medium of claim 39, wherein the resource allocation comprises a scheduling assignment allocating at least the frequency in an unlicensed frequency band.
